(19) United States
(12) Patent Application Publication
(10) Pub. No.: US 2014/0181375 A1
(43) Pub. Date: Jun. 26, 2014

(54) MEMORY CONTROLLER

(71) Applicant: Kabushiki Kaisha Toshiba, Minato-ku (JP)

(72) Inventors: Arata MIYAMOTO, Tokyo (JP); Hiroshi YAO, Kanagawa (JP); Yu NAKANISHI, Kanagawa (JP); Daisuke IWAI, Kanagawa (JP); Naomi TAKEDA, Kanagawa (JP); Daiki WATANABE, Kanagawa (JP)

(21) Appl. No.: 13/928,586

(22) Filed: Jun. 27, 2013

Related U.S. Application Data
(60) Provisional application No. 61/740,274, filed on Dec. 20, 2012.

(51) Int. Cl. G06F 12/02

(52) U.S. Cl. CPC G06F 12/0246
USPC 711/103

(57) ABSTRACT

According to one embodiment, a memory controller includes a first interface, a second interface, a cache unit, a translation unit, an access unit and a lock unit. The first interface receives a lock request and an access request which includes a logical address. The second interface is connectable to a non-volatile memory. The cache unit comprises a plurality of cache line and caches correspondence information between the logical address and a physical address of the non-volatile memory. The translation unit translates the logical address included in the access request into the physical address with reference to the cache unit. The access unit performs access in accordance with the access request to a position indicated by the translated physical address. The lock unit sets the cache line lock state in accordance with the lock request. The lock state is the state where the cache line being prohibited to be refilled.

### CROSS-REFERENCE TO RELATED APPLICATIONS

This application is based upon and claims the benefit of priority from U.S. Provisional Patent Application No. 61/740,274, filed on Dec. 20, 2012; the entire contents of which are incorporated herein by reference.

### FIELD

Embodiments described herein relate generally to a memory controller.

### BACKGROUND

A memory controller controls a NAND flash memory (hereinafter, referred to as a NAND memory) maps a logical address and a physical address. Hereinafter, data indicating the correspondence between the logical address and the physical address is referred to as an L2P (Logical To Physical) table.

The L2P table is stored in a system data area which is allocated to a part of the NAND memory. The L2P table is stored on a RAM of the memory controller.

### BRIEF DESCRIPTION OF THE DRAWINGS

FIG. 1 is a diagram illustrating the structure of a memory controller according to a first embodiment;

FIG. 2 is a diagram illustrating correspondence between a logical address and a physical address;

FIG. 3 is a diagram illustrating examples of a lock request, an unlock request, and an access request for a cache line;

FIG. 4 is a diagram illustrating an example of the operation of the cache line by an address resolution unit;

FIG. 5 is a flowchart illustrating the operation of the address resolution unit when the access request is received;

FIG. 6 is a flowchart illustrating a first selection process;

FIG. 7 is a flowchart illustrating a second selection process;

FIG. 8 is a diagram illustrating an example of a request to designating a region number instead of a cache line number;

FIG. 9 is a diagram illustrating the structure of a memory controller according to a second embodiment;

FIG. 10 is a diagram illustrating an example of an access pattern;

FIG. 11 is a diagram illustrating the number of refills for each region;

FIG. 12 is a flowchart illustrating the operation of a lock determining unit; and

FIG. 13 is a flowchart illustrating another operation of the lock determining unit.

### DETAILED DESCRIPTION

In a memory controller without a high-capacity RAM, an L2P table is divided into entries with an appropriate size and necessary entries are read onto a RAM. In this way, mapping is achieved. Each entry of the L2P table stores mapping information in a specific range of consecutive logical addresses. An entry storage region of the RAM can have a cache structure. Therefore, when an access pattern has locality in a logical address space, it is possible to reduce the number of times the entry of the L2P table (hereinafter, referred to as a table entry) is read from a NAND memory.

One of the access patterns for improving the hit ratio is that some logical addresses are repeatedly accessed in order. However, this is limited to a case in which the number of table entries (hereinafter, referred to as a repetition interval) which are referred to in one cycle of the access pattern is less than the number of cache lines. When the repetition interval is more than the number of cache lines and the access pattern returns to the initial point after one cycle, the table entry needs to be read from the NAND memory again since the previous table entry has been sent out of the cache. This is similar to a thrashing which occurs on a CPU cache when a program loop with a large code is executed.

For example, such a thrashing is likely to occur when a host uses a file system with a journaling function. When user data is written to a storage, the file system with the journaling function records a change log indicating a change in content in the unit of transaction, in addition to the user data. The change log is recorded at a position that is away from the user data in order to respond to a burst error in the storage. The change in the user data and the change log corresponding to the change are certainly recorded as a set in the storage. Therefore, access to a region in which the user data is stored and access to a region in which the change log is stored occur alternately.

The region in which the change log is stored is generally ensured as a ring buffer. Whenever transaction occurs, a new change log is additionally described at the end of the buffer. Therefore, when attention is focused only on the change log, it is considered that sequential access occurs. However, since the user data is written during the recording of the change log, the repetitive access described above, not complete sequential access, is achieved. When the number of table entries required during the writing of the user data is less than the number of cache lines, the table entry which has been cached during the previous recording of the change log is likely to remain on the cache during the next writing of the change log. In this case, since the table entry for a ring buffer which has been read is referred to even during the subsequent writing of the change log, the hit ratio of the cache is high. On the other hand, when the number of table entries required during the writing of the user data is more than the number of cache lines, the table entry for a ring buffer is sent out of the cache during the recording of the change log. In this case, it is necessary to read the table entry for a ring buffer from the NAND memory whenever the change log is recorded. As a result, the above-mentioned thrashing occurs and the hit ratio of the cache is reduced.

A memory controller according to an embodiment of the invention has a function of locking the cache line in order to prevent the occurrence of thrashing on the cache which temporarily stores the L2P table. According to the embodiment of the invention, the table entry on the locked cache line is not sent out of the cache until the cache line is unlocked. According to this function, when the repetition interval is more than the number of cache lines, it is possible to improve the hit ratio of the cache. When there is a ring buffer for the change log, the table entry corresponding to the logical address indicating the current write pointer in the ring buffer is locked to improve the hit ratio of the cache.

In general, according to one embodiment, the memory controller includes a first interface, a second interface, a cache unit, a translation unit, an access unit and a lock unit. The first interface receives a lock request and an access request which includes a logical address. The second interface is connectable to a non-volatile memory. The cache unit comprises a plurality of cache line and caches correspondence information between the logical address and a physical address of the non-volatile memory. The translation unit translates the logical address included in the access request into the physical address with reference to the cache unit. The access unit performs access in accordance with the access request to a position indicated by the translated physical address. The lock unit sets the cache line lock state in accordance with the lock request. The lock state is the state where the cache line being prohibited to be refilled.

Exemplary embodiments of the memory controller will be explained below in detail with reference to the accompanying drawings. The present invention is not limited to the following embodiments.

### First Embodiment

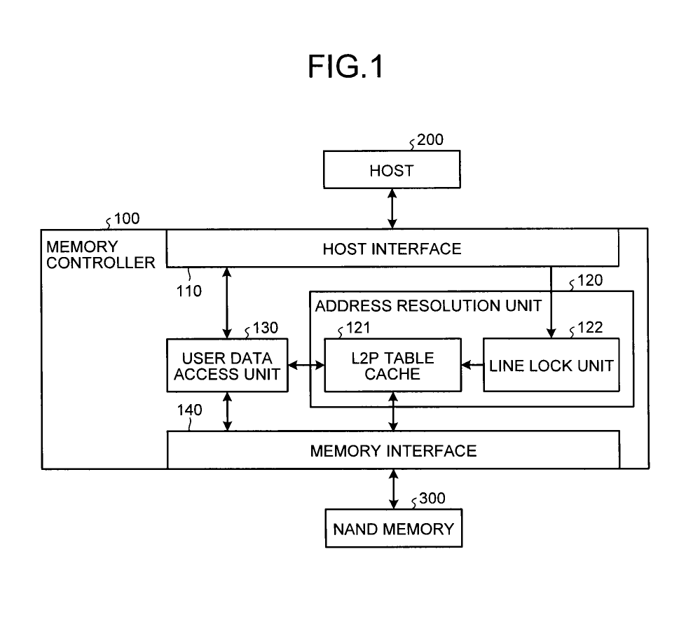

FIG. 1 is a diagram illustrating the structure of a memory controller according to a first embodiment. As illustrated in FIG. 1, a memory controller 100 is connected to a host 200 and a NAND memory 300. The memory controller 100 transmits data between the host 200 and the NAND memory 300 in response to a read request or a write request from the host 200. Hereinafter, in some cases, the read request and the write request are generically referred as an access request. The access request includes the designation of the logical address of an access destination. The memory controller 100 calculates a physical address corresponding to the designated logical address. Then, the memory controller 100 performs the requested access to the position indicated by the physical address in the NAND memory 300.

The memory controller 100 includes a host interface (first interface) 110, an address resolution unit (translation unit) 120, a user data access unit (access unit) 130, and a memory interface (second interface) 140.

The host interface 110 is used for communication with the host 200. The host interface 110 can receive a lock request and an unlock request from the host 200 in addition to the access request. The memory interface 140 is used for communication with the NAND memory 300.

The user data access unit 130 reads data which is requested to be read by the host 200 from the NAND memory 300 through the memory interface 140. In addition, the user data access unit 130 writes data which is requested to be written by the host 200 to the NAND memory 300 through the memory interface 140. The user data access unit 130 receives the physical address of the access destination from the address resolution unit 120 and receives an ID indicating the kind of request from the host 200 from the host interface 110.

The address resolution unit 120 translates the logical address which is designated by the host 200 using the access request into a physical address (address resolution). Here, the address resolution unit 120 includes an L2P table cache (cache unit) 121 in order to resolve the address at a high speed.

Each cache line of the L2P table cache 121 is identified by a cache line number. The line size of the L2P table cache 121 is equal to the size of a table entry. The range of the logical address covered by one table entry is predetermined. Each table entry is a set of key-value pairs each of which includes each logical address in the range and the physical address corresponding to the logical address. The range of the logical addresses covered by one table entry is referred to as a region.

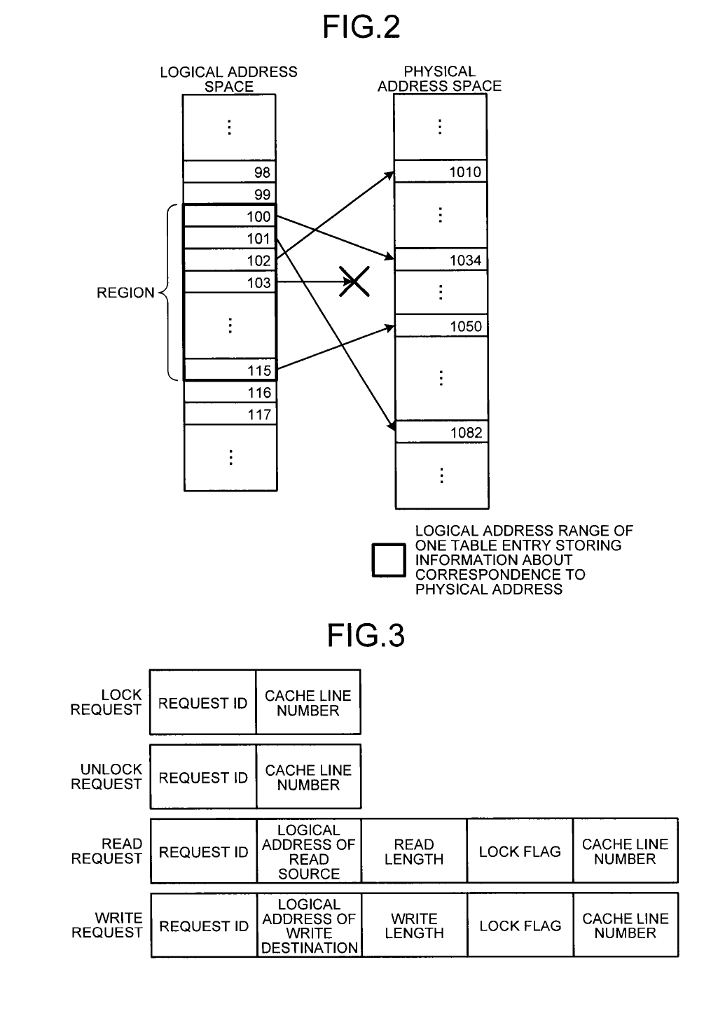

FIG. 2 is a diagram illustrating the correspondence between the logical address and the physical address. In FIG. 2, one table entry covers 16 consecutive logical addresses. One table entry stores the physical address corresponding to each logical address. Here, for example, a logical address “100” corresponds to a physical address “1034” and a logical address “101” corresponds to a physical address “1082”. A logical address “103” does not correspond to any physical address, which means that no user data is stored at the logical address.

The address resolution unit 120 calculates the physical address corresponding to the logical address with reference to the L2P table cache 121 and transmits the calculated physical address to the user data access unit 130.

The content (correspondence information) of the L2P table is stored in the NAND memory 300. The address resolution unit 120 can read the table entry stored in the NAND memory 300 to the cache line of the L2P table cache 121 through the memory interface 140. In addition, the address resolution unit 120 writes the table entry cached in the L2P table cache 121 back to the NAND memory 300. Hereinafter, an operation of reading the table entry to the cache line of the L2P table cache 121 is referred to as a refilling operation. When the table entry on the cache line, which is a read destination, is dirty, an operation of sending (writing back) the dirty table entry to the NAND memory 300 is performed prior to the refilling operation.

Here, the address resolution unit 120 includes a line lock unit 122. The address resolution unit 120 receives a lock request and an unlock request for the L2P table cache 121 from the host 200 through the host interface 110. The lock request is a request to lock the cache line. The unlock request is a request to unlock the cache line. The line lock unit 122 locks or unlocks the cache line in response to the request from the host 200. Here, locking the cache line means prohibiting the table entry from being sent out of the cache line except when a specific request (an access request in which a lock flag described below is set to be valid) is received. Therefore, locking the cache line means prohibiting the cache line from being refilled. In addition, unlocking the cache line means removing the prohibition of the sending-out of the data. When the cache line is unlocked, it is possible to refill the cache line. In addition, the line lock unit 122 can lock a plurality of cache lines at the same time.

FIG. 3 is a diagram illustrating examples of the lock request, the unlock request, and the access request for the cache line. The lock request and the unlock request each have the cache line number as a parameter. In addition, the access request has a lock flag and the cache line number as parameters in addition to the logical address of the access destination (a read source or a write destination) and an access length (a read length or a write length). The requests illustrated in FIG. 3 indicate only the minimum necessary fields. The lock request, the unlock request, the read request, or the write request may include other parameters according to the structure of the host interface 110.

The cache line number in the lock request and the unlock request indicates the cache line to be locked or unlocked. The lock flag in the access request indicates whether to lock a table entry for the region to be accessed by a command on the L2P table cache 121. In addition, the cache line number in the access request indicates the cache line onto which data will be read when the lock flag is valid. However, the cache line number which can be designated in the access request is limited to the line which has been locked.

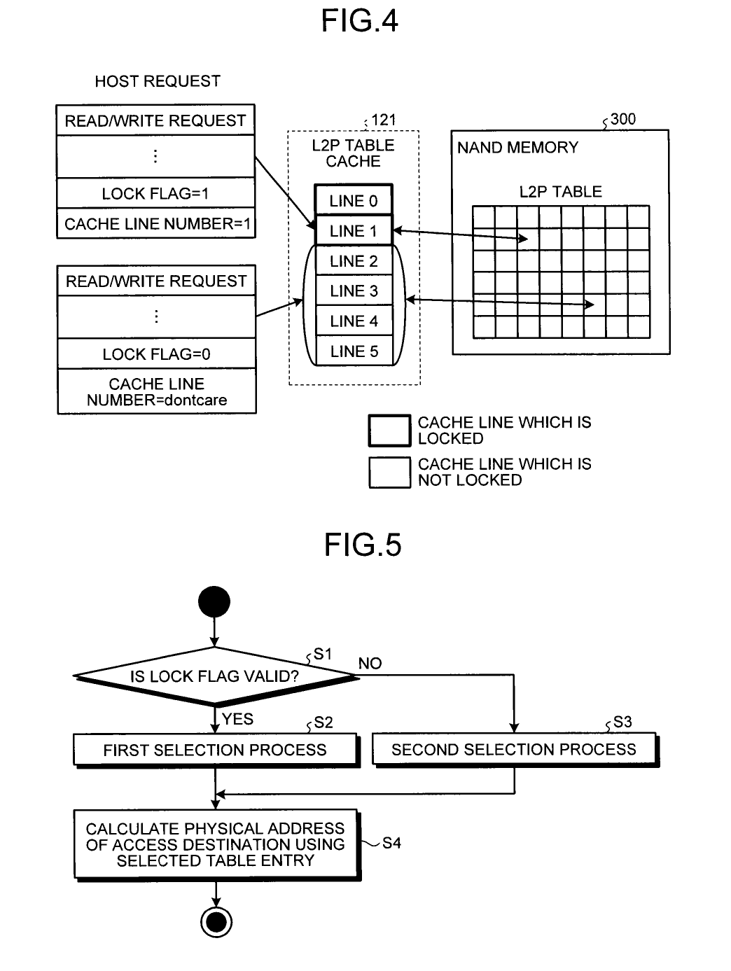

FIG. 4 is a diagram illustrating an example of the operation of the cache line by the address resolution unit 120. When receiving the access request in which the lock flag is invalid (here, “0” is set to the lock flag), the address resolution unit 120 reads the L2P table entry for the region of the access destination to any one of the cache lines which are not locked. When receiving the access request in which the lock flag is valid (here, “1” is set to the lock flag), the address resolution unit 120 reads the L2P table entry to the cache line indicated by the cache line number. The access request in which the lock flag is valid does not cause the reading of data onto the cache line which is not locked. In addition, the access request in which the lock flag is invalid does not cause the rewriting of the locked cache line.

The chip structure of the host 200, the memory controller 100, and the NAND memory 300 is not particularly limited. The memory controller 100 may be formed by a chip which is independent from the host 200. In addition, a processor of the host 200 may execute a predetermined program to implement the memory controller 100. Only the address resolution unit 120 may be implemented by the processor of the host 200 and the other components may be included in a chip which is independent from the host 200. A non-volatile memory device may be used instead of the NAND memory 300.

Next, the operation of the memory controller 100 according to the first embodiment will be described.

When the address resolution unit 120 receives the lock request, the line lock unit 122 locks the cache line with the number indicated by the received lock request. When the address resolution unit 120 receives the unlock request, the line lock unit 122 unlocks the cache line with the number indicated by the received unlock request.

FIG. 5 is a flowchart illustrating the operation of the address resolution unit 120 when the access request is received. When receiving the access request, the address resolution unit 120 determines whether the lock flag in the received access request is valid (Step S1). When the lock flag is valid (Yes in Step S1), the address resolution unit 120 performs a process (first selection process) of selecting a table entry from the locked cache line (Step S2). When the lock flag is invalid (No in Step S1), the address resolution unit 120 performs a process (second selection process) of selecting a table entry from the cache line which is not locked (Step S3). After Step S2 or Step S3, the address resolution unit 120 calculates the physical address of the access destination using the selected table entry (Step S4) and ends the operation.

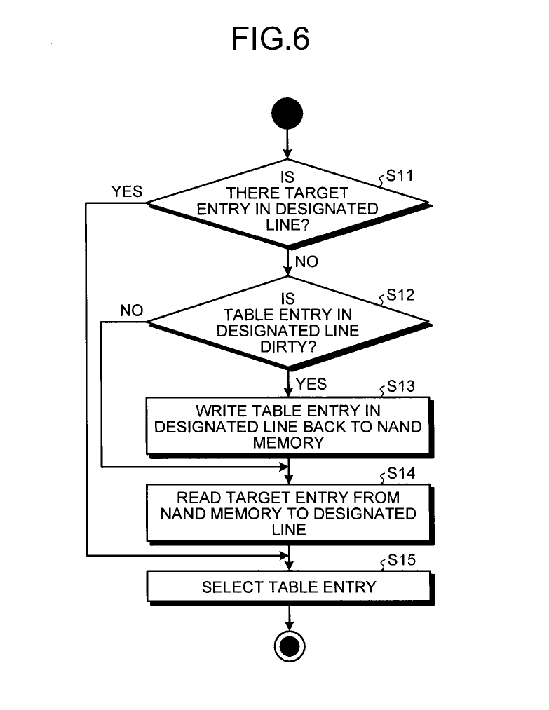

FIG. 6 is a flowchart illustrating the first selection process. The address resolution unit 120 determines whether there is a table entry (target entry) for an access target region in the cache line (designated line) designated by the access request (Step S11). When there is no target entry in the designated line (No in Step S11), the address resolution unit 120 determines whether the table entry in the designated line is dirty (Step S12). When the table entry in the designated line is dirty (Yes in Step S12), the address resolution unit 120 writes the table entry in the designated line back to the NAND memory 300 (Step S13) and reads the target entry from the NAND memory 300 to the designated line (Step S14). When the table entry in the designated line is not dirty (No in Step S12), the address resolution unit 120 skips Step S13 and performs Step S14. After Step S14, the address resolution unit 120 selects the table entry in the designated line (Step S15) and ends the process of selecting the table entry for a lock region. When there is a target entry in the designated line (Yes in Step S11), the address resolution unit 120 performs Step S15.

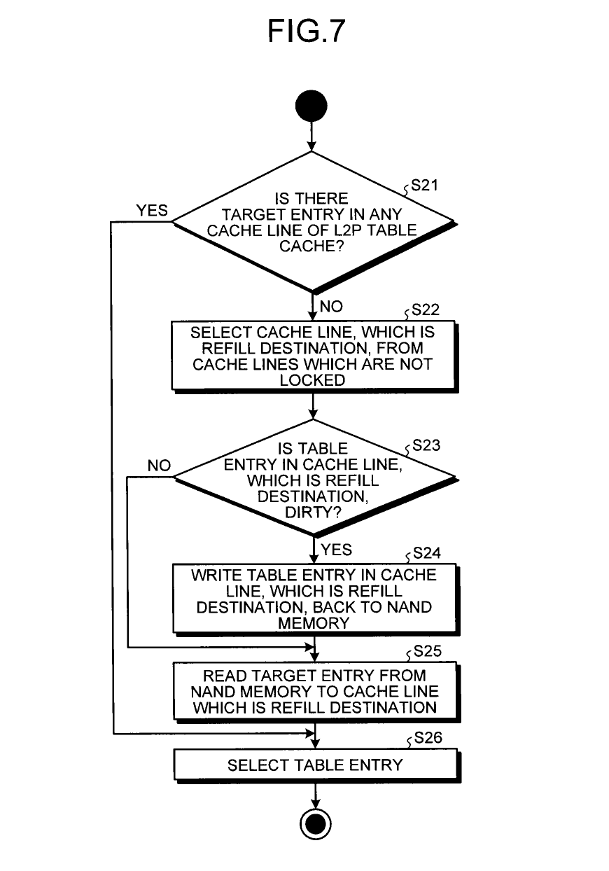

FIG. 7 is a flowchart illustrating the second selection process. The address resolution unit 120 determines whether the target entry is included in any cache line including the locked cache line of the L2P table cache 121 (Step S21). When there is no target entry (No in Step S21), the address resolution unit 120 selects a cache line, which is a refill destination, from the cache lines which are not locked (Step S22). The address resolution unit 120 determines whether the table entry in the cache line, which is the refill destination, is dirty (Step S23). When the table entry in the cache line, which is the refill destination, is dirty (Yes in Step S23), the address resolution unit 120 writes the table entry in the cache line, which is the refill destination, back to the NAND memory 300 (Step S24) and reads the table entry in the cache line, which is the refill destination, from the NAND memory 300 (Step S25). When the table entry in the cache line, which is the refill destination, is not dirty (No in Step S23), the address resolution unit 120 skips Step S24 and performs Step S25. After Step S25 or when the target entry is included in any cache line of the L2P table cache 121 (Yes in Step S21), the address resolution unit 120 selects the target entry which is included in the L2P table cache 121 or the target entry which is read in Step S25 (Step S26). Then, the address resolution unit 120 ends the process of selecting the table entry for the lock region.

In the above-mentioned example, the host 200 explicitly designates the cache line number in the lock request, the unlock request, and the access request. The host 200 can refill the stored table entry using the access request in which the lock flag is valid, without unlocking the locked cache line. Therefore, the host 200 can use the locked cache line like a scratch pad with high flexibility.

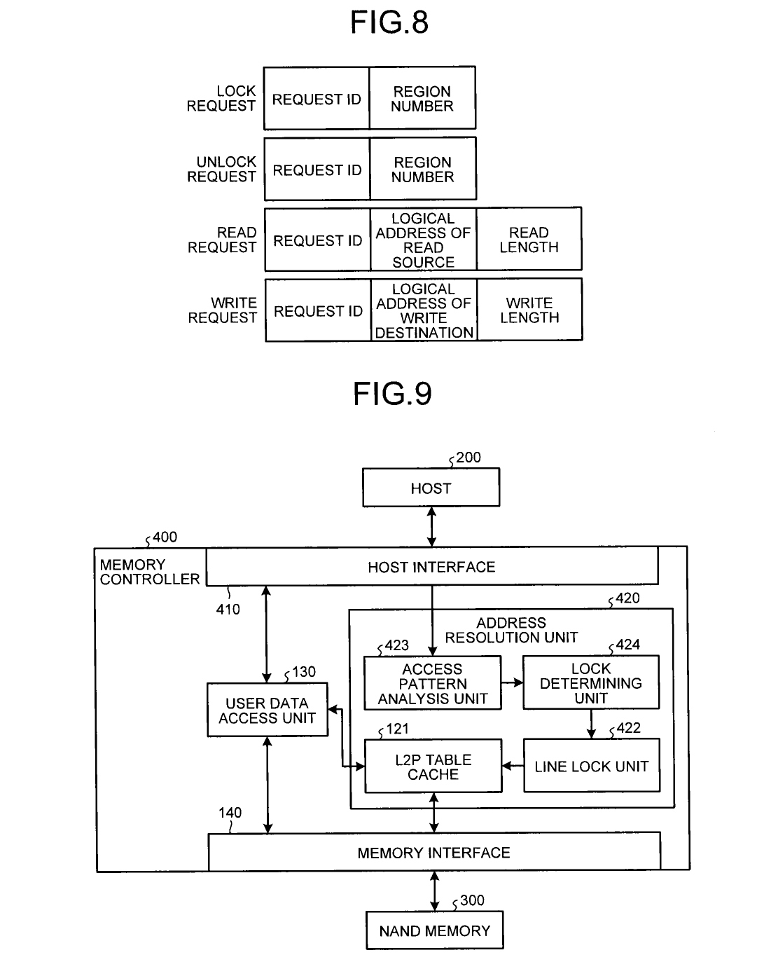

As in the example illustrated in FIG. 8, the memory controller 100 may be configured so as to receive a request to designate a region number, instead of the cache line number. That is, when receiving the lock request, the line lock unit 122 selects one cache line which is not locked using any method, reads the target entry to the selected cache line, and locks the cache line. When receiving the unlock request, the line lock unit 122 unlocks the cache line including the target entry. The access request includes neither the lock flag nor the cache line number. When the region including the logical address of the access destination corresponds to any region designated in the lock request, the address resolution unit 120 refers to the table entry in the locked cache line for the region. When the region including the logical address of the access destination does not correspond to any region designated in the lock request, the address resolution unit 120 performs a general cache operation using the cache line which is not locked. The use of the requests illustrated in FIG. 8 makes it unnecessary for the host 200 to recognize the locked cache line. Therefore, it is possible to reduce the load of the host. However, the host 200 needs to unlock the cache line in order to refill the locked cache line.

When the number of locked cache lines increases significantly, the cache entry which can be freely used is insufficient. As a result, there is a concern that the processing speed of a command in which the lock flag is invalid will be reduced. Therefore, the upper limit may be set to the number of cache lines which can be locked at the same time.

As described above, according to the first embodiment, the memory controller 100 locks or unlocks the independent cache lines of the L2P table cache 121 in response to the request from the host 200. In this way, the host 200 can lock the cache line caching the region which is periodically accessed and has an access interval more than the number of cache lines, thereby preventing the occurrence of thrashing. That is, the memory controller 100 can perform address resolution as quickly as possible. In addition, when the host 200 has a journaling function, the host 200 can lock the table entry corresponding to the position of the current write pointer on a ring buffer to prevent the occurrence of thrashing.

### Second Embodiment

According to the first embodiment, the memory controller 100 locks and unlocks the cache line in response to the requests from the host 200. Therefore, the host 200 needs to manage the table entry in the locked cache line.

In contrast, in a second embodiment, the memory controller determines a lock target and lock timing. That is, the memory controller can lock and unlock the cache line without any request from the host 200. According to the second embodiment, the locking and unlocking of the cache line are transparently performed for the host 200. Therefore, the load of the host 200 is reduced, as compared to the first embodiment in which the host 200 needs to explicitly control the locking and unlocking of the cache line.

FIG. 9 is a diagram illustrating the structure of a memory controller according to the second embodiment. In the second embodiment, the same components as those in the first embodiment are represented by the same names and reference numerals and the description thereof will not be repeated. A memory controller 400 is connected to a host 200 and a NAND memory 300.

The memory controller 400 includes a host interface 410, an address resolution unit 420, a user data access unit 130, and a memory interface 140.

The host interface 410 is used for communication with the host 200. The host interface 410 may be configured so as to be incapable of receiving the requests illustrated in FIG. 3 or FIG. 8 from the host 200.

The address resolution unit 420 includes an L2P table cache 121, a line lock unit 422, an access pattern analysis unit (access pattern recording unit) 423, and a lock determining unit (lock unit) 424.

In order to determine the table entry to be locked, the access pattern analysis unit 423 analyzes the pattern of the access (access pattern) of the host 200 to each region and stores the analysis result. Specifically, for example, the access pattern analysis unit 423 calculates the number of refills for the access of the host 200 for each region and stores the calculation result. The number of refills for a given region at a certain moment is the number of refills in the L2P table cache 121 for the period from the previous access to the current access to the region.

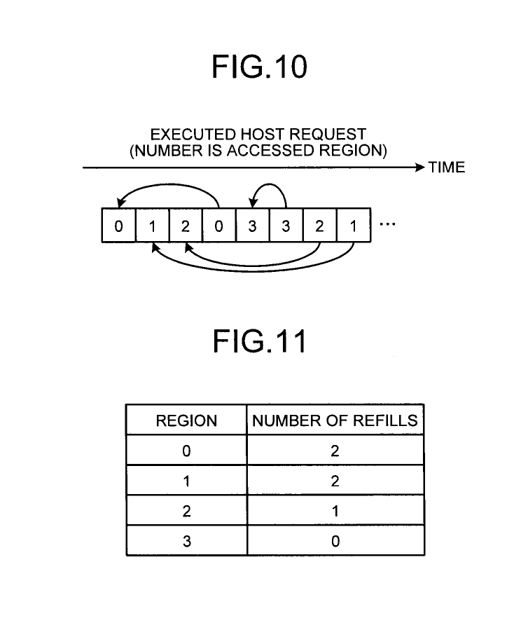

FIG. 10 is a diagram illustrating an example of the access pattern. FIG. 11 is a diagram illustrating the number of refills for each region when the number of cache lines is four and access is performed in the access pattern illustrated in FIG. 10. It is assumed that access is performed in the order of regions 0, 1, 2, 0, 3, 3, 2, and 1 in a state in which all cache lines are empty. For example, region 1 and region 2 are accessed for the period from the first access to the second access to region 0. Neither the table entry of region 1 nor the table entry of region 2 is present on the cache line and a refill operation is performed for each cache line. Therefore, the number of refills for region 0 after the second access is two. Similarly, region 0, region 2, and region 3 are accessed for the period from the first access to the second access to region 1. Since region 0 is previously accessed, there is the table entry of region 0 on the cache line. Therefore, the refill operation is performed only when region 2 and region 3 are accessed and the number of refills for region 1 after the second access is two. Similarly, the number of refills for region 2 is one and the number of refills for region 3 is zero.

The number of refills is an index for measuring the strength of locality for the corresponding region. The strength of the locality is determined according to the number of refills as follows:

(1) A region satisfying the relation (the number of refills)<(the number of cache lines) is determined to have “strong” locality. During the next access to the region with “strong” locality, the table entry of the region remains in the cache (the cache is hit). A region with an access interval less than the number of cache lines corresponds to the region with “strong” locality.

(2) A region satisfying the relation (the number of cache lines)≦(the number of refills)<(refill number threshold value) is determined to have “medium” locality. Even when the region with “medium” locality is periodically accessed, the table entry of the region does not remain in the cache during the next access since the access interval is more than the number of cache lines (the cache is missed). In addition, since the number of refills for the region with “medium” locality is less than the refill number threshold value, the access interval of the region with “medium” locality is less than that of a region with “weak” locality, which will be described below.

(3) A region satisfying the relation (refill number threshold value)≦(the number of refills) is determined to have “weak” locality. Even when the region with “weak” locality is periodically accessed, the table entry of the region does not remain in the cache during the next access since the access interval is more than the refill number threshold value (the cache is missed).

The memory controller 400 locks the cache line corresponding to the region with “medium” locality. Even when the cache line corresponding to the region with “strong” locality is not locked, the cache is hit. Therefore, the cache line is not a lock target. In addition, since the frequency of access to the cache line corresponding to the region with “weak” locality is low, the cache line is not a lock target. When the cache line corresponding to the region with “weak” locality is locked, the number of cache lines which can be used for other regions is reduced. As a result, the cache hit ratio of the entire storage is reduced.

When refilling occurs, the lock determining unit 424 determines whether the region of the refilled table entry locks the refilled cache line on the basis of whether the region satisfies the relation (2). The storage position of the refill number threshold value for determination is not particularly limited. For example, the refill number threshold value for determination is predetermined. The lock determining unit 424 transmits the determination result indicating whether to lock the cache line to the line lock unit 422. The line lock unit 422 locks the cache line according to the transmitted determination result. Hereinafter, in some cases, the locking of the cache line is expressed as the locking of the region. In addition, in some cases, the unlocking of the cache line is expressed as the unlocking of the region.

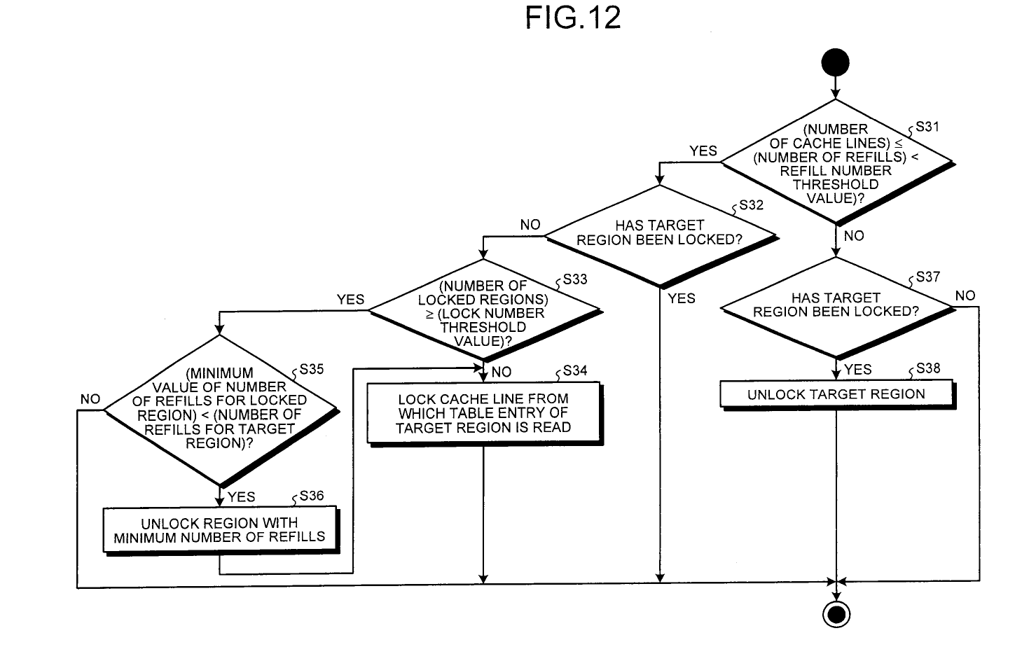

FIG. 12 is a flowchart illustrating the operation of the lock determining unit 424. The operation illustrated in FIG. 12 is performed for the region (target region) from which the table entry is read in the NAND memory 300 by refilling when refilling occurs.

The lock determining unit 424 determines whether the target region satisfies the determination conditions of “medium” locality, that is, the relation (the number of cache lines)≦(the number of refills)<(refill number threshold value) (Step S31). When the target region satisfies the determination conditions of “medium” locality (Yes in Step S31), the lock determining unit 424 determines whether the target region has already been locked (Step S32).

When the target region has already been locked (Yes in Step S32), the lock determining unit 424 ends the operation for the target region. When the target region has not been locked (No in Step S32), the lock determining unit 424 determines whether the number of locked regions is equal to or greater than a lock number threshold value (Step S33). The storage position of the lock number threshold value is not particularly limited. For example, the lock number threshold value is predetermined.

When the number of locked regions is not equal to or greater than the lock number threshold value (No in Step S33), the lock determining unit 424 directs the line lock unit 422 to lock the cache line from which the table entry corresponding to the target region is read (Step S34).

When the number of locked regions is equal to or greater than the lock number threshold value (Yes in Step S33), the lock determining unit 424 determines whether the minimum value of the number of refills for the locked region is less than the number of refills for the target region (Step S35). When the minimum value of the number of refills for the locked region is not less than the number of refills for the target region (No in Step S35), the lock determining unit 424 ends the operation for the target region. When the minimum value of the number of refills for the locked region is less than the number of refills for the target region (Yes in Step S35), the lock determining unit 424 directs the line lock unit 422 to unlock the region with the minimum number of refills among the locked regions (Step S36) and performs Step S34.

When the target region does not satisfy the determination conditions of the “medium” locality (No in Step S31), the lock determining unit 424 determines whether the target region has been locked (Step S37). When the target region has been locked (Yes in Step S37), the lock determining unit 424 directs the line lock unit 422 to unlock the target region (Step S38) and ends the operation for the target region. When the target region has not been locked (No in Step S37), the lock determining unit 424 skips Step S38 and ends the operation for the target region.

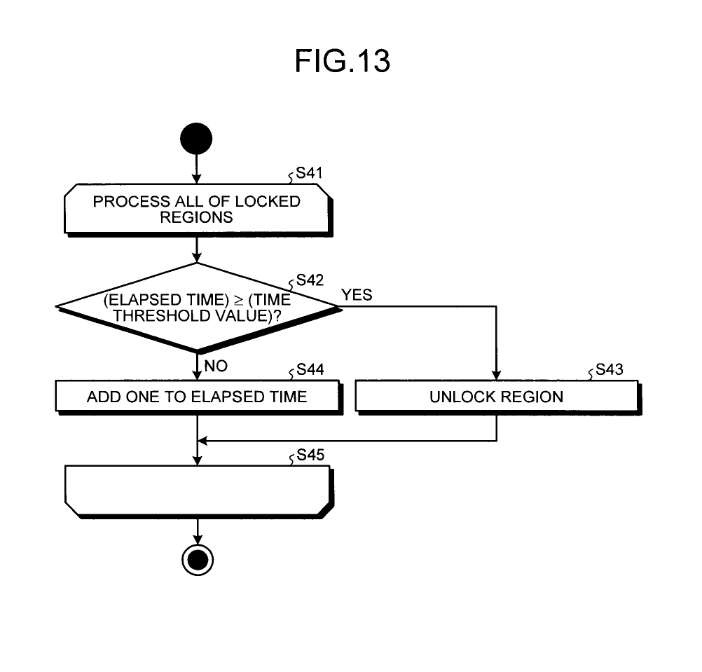

FIG. 13 is a flowchart illustrating another operation of the lock determining unit 424. The operation illustrated in FIG. 13 is performed in parallel to the operation illustrated in FIG. 12. The lock determining unit 424 performs a loop of Step S41 to Step S45 for all of the locked regions. In addition, the lock determining unit 424 performs the operation described with reference to FIG. 13 when refilling occurs.

The lock determining unit 424 starts the loop process for a focused region among the locked regions. The lock determining unit 424 determines whether the time elapsed from the locking of the focused region is equal to or greater than a time threshold value (Step S42).

The elapsed time means the number of refills which occur after locking. The number of refills stored in the access pattern analysis unit 423 is the number of refills between the latest two accesses. The time taken for the lock determining unit 424 to perform Step S42 is the number of refills after the latest access is performed. The storage position of the time threshold value is not particularly limited. In addition, for example, the time threshold value is predetermined. The refill number threshold value may be used as the time threshold value.

When the elapsed time after locking is equal to or greater than the time threshold value (Yes in Step S42), the lock determining unit 424 unlocks the focused region (Step S43). When the elapsed time after locking is not equal to or greater than the time threshold value (No in Step S42), the lock determining unit 424 adds one to the elapsed time for the focused region (Step S44). After Step S43 or Step S44, the lock determining unit 424 performs the next loop process for another focused region.

When a region is locked once and access to the region is not performed for a long time due to a change in the access pattern, the operation illustrated in FIG. 13 makes it possible to unlock the region. That is, it is possible to prevent the region which has low access frequency and is locked for a long time from occupying the cache line. On the other hand, in a case in which the frequency of access to the region with high access frequency is temporarily reduced and locked and the table entry for the region is sent out of the cache line, when the frequency of access is restored and the next access to the region is performed, the region is refilled and is locked again by the operation illustrated in FIG. 12.

In the above description, when the number of locked regions is equal to or greater than the lock number threshold value, the lock determining unit 424 unlocks the locked region to lock a new region. When the number of locked regions is equal to or greater than the lock number threshold value, the lock determining unit 424 may not lock the target region.

The access pattern analysis unit 423 may store the average value (moving average value) or the maximum value (approximate maximum value) of the number of refills as the access pattern and the lock determining unit 424 may compare the value stored in the access pattern analysis unit 423 with the refill number threshold value. In addition, the access pattern analysis unit 423 may store the weighted average (weighted average value) between the previous number of refills and the current number of refills. The use of the moving average value, the approximate maximum value, and the weighted average value makes it possible to reduce the influence of a rapid change in the number of refills due to a variation in the access interval. For example, the access pattern analysis unit 423 may update the number of refills stored for each region using the following Expression:

(the number of refills after update)=(the number of refills before update)*W+(the current number of refills)*(1−W)

(where W is a predetermined weight coefficient satisfying 0≦W≦1).

In this embodiment, the lock determining unit 424 determines the unlock timing using the number of refills as the elapsed time. However, the lock determining unit 424 may include a timer, such as a counter, and determine the unlock timing on the basis of the output of the timer.

In addition, the access pattern analysis unit 423 may calculate an access period on the basis of the previous value of the number of refills between accesses and record the calculated access period. In this case, the lock determining unit 424 may divide each region into three regions in ascending order of the access period and lock the second region in ascending order of the access period.

As described above, according to the second embodiment, the memory controller 400 determines the cache line to be locked and the lock timing on the basis of the access pattern of the host 200. Therefore, the memory controller 400 can perform address resolution as quickly as possible.

In addition, the memory controller 400 locks the region satisfying the following relation (the number of cache lines)≦(the number of refills)<(refill number threshold value). Therefore, when an appropriate refill number threshold value corresponding to the access pattern is set, it is possible to reduce the occurrence of thrashing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller comprising:
a first interface that receives a lock request and an access request which includes a logical address;
a second interface that is connectable to a non-volatile memory;
a cache unit that comprises a plurality of cache line and caches correspondence information between the logical address and a physical address of the non-volatile memory;
a translation unit that translates the logical address included in the access request into the physical address with reference to the cache unit;
an access unit that performs access in accordance with the access request to a position of the non-volatile memory indicated by the translated physical address; and
a lock unit that sets the cache line lock state in accordance with the lock request, the lock state being the state where the cache line being prohibited to be refilled.

2. The memory controller according to claim 1,
wherein the first interface unit receives an unlock request, and
the lock unit sets the cache line unlock state in accordance with the unlock request, the unlock state being the state where the cache line being allowed to be refilled.

3. The memory controller according to claim 2,
wherein the lock request includes designation of the cache line to be locked and the unlock request include designation of the cache line to be unlocked.

4. The memory controller according to claim 3,
wherein the access request includes a flag and the designation of the cache line, and
when the cache line is in lock state, the lock unit prohibits refilling to the cache line in response to the access request when the flag is invalid and allows the refilling to the cache line in response to the access request when the flag is valid.

5. The memory controller according to claim 2,
wherein the lock request and the unlock request include the designation of a range of the logical address,
the lock unit sets the cache line in which the correspondence information for the range designated by the lock request is cached lock state, and sets the cache line in which the correspondence information for the range designated by the lock request is cached unlock state.

6. The memory controller according to claim 1,
wherein the non-volatile memory is a NAND flash memory.

7. A memory controller comprising:
a first interface that receives an access request includes a logical address;
a second interface that is connectable to a non-volatile memory;
a cache unit that comprises a plurality of cache line and caches correspondence information between the logical address and a physical address of the non-volatile memory;
a translation unit that translates the logical address included in the access request into the physical address with reference to the cache unit;
an access unit that performs access in accordance with the access request to a position of the non-volatile memory indicated by the translated physical address;
an access pattern monitoring unit that monitors an access pattern to the non-volatile memory; and
a lock unit that sets a cache line lock state according to the monitored access pattern of the access pattern monitoring unit, the lock state being the state where the cache line being prohibited to be refilled.

8. The memory controller according to claim 7,
wherein the lock unit sets the cache line unlock state according to the monitored access pattern of the access pattern monitoring unit, the unlock state being the state where the cache line being allowed to be refilled.

9. The memory controller according to claim 8,
wherein, when the number of cache lines which are in the lock state is greater than a threshold value, the lock unit selects the cache line among the cache lines in the lock state according to the monitored access pattern of the access pattern monitoring unit and set to unlocked state.

10. The memory controller according to claim 7,
wherein the correspondence information comprises a plurality of entries each being an unit of being cached in the cache unit and each corresponding to each logical address region, and
the access pattern monitoring unit monitors the number of times of refills performed between accesses for each logical address region as the access pattern.

11. The memory controller according to claim 10,
wherein the lock unit sets the cache lines lock state when the number of times of refills monitored by the access pattern monitoring unit is more than the number of cache lines in the cache unit and is less than a threshold value.

12. The memory controller according to claim 11,
wherein the lock unit sets the cache line unlock state when the cache line in lock state is not accessed for a period of time.

13. The memory controller according to claim 8,
wherein the correspondence information comprises a plurality of entries each being an unit of being cached in the cache unit and each corresponding to each logical address region, and
the access pattern monitoring unit monitors the number of times of refills performed between accesses for each logical address region as the access pattern.

14. The memory controller according to claim 13,
wherein the lock unit sets the cache lines lock state when the number of times of refills monitored by the access pattern monitoring unit is more than the number of cache lines in the cache unit and is less than a threshold value, and
the lock unit sets the cache line unlock state when the number of times of refills monitored by the access pattern monitoring unit is less than the number of cache lines in the cache unit or is more than the threshold value.

15. The memory controller according to claim 9,
wherein the correspondence information comprises a plurality of entries each being an unit of being cached in the cache unit and each corresponding to each logical address region, and
the access pattern monitoring unit monitors the number of times of refills performed between accesses for each logical address region as the access pattern.

16. The memory controller according to claim 15,
wherein the lock unit sets the cache lines lock state when the number of times of refills monitored by the access pattern monitoring unit is more than the number of cache lines in the cache unit and is less than a first threshold value, and
the lock unit sets the cache line in which the number of times of refills monitored by the access pattern monitoring unit is the minimum among the cache lines which are in the lock state when the number of cache lines which are in the lock state is greater than a second threshold value.

17. The memory controller according to claim 7,
wherein the correspondence information comprises a plurality of entries each being an unit of being cached in the cache unit and each corresponding to each logical address region, and
the access pattern monitoring unit monitors a moving average value, an approximate maximum value, or a weighted average value of the number of refills times of refills performed between accesses for each logical address region as the access pattern.

18. The memory controller according to claim 7,
wherein the non-volatile memory is a NAND flash memory.
